(19) United States
(12) Patent Application Publication
(10) Pub. No.: US 2021/0101440 A1
(43) Pub. Date: Apr. 8, 2021

(54) AUTOMOBILE AIR CONDITIONER BLOWING ADJUSTING SHIFTING PIECE BUCKLE STRUCTURE

(71) Applicant: Shunqing Wang, Xiangtan (CN)

(72) Inventor: Shunqing Wang, Xiangtan (CN)

(21) Appl. No.: 17/126,062

(22) Filed: Dec. 18, 2020

(30) Foreign Application Priority Data
Jan. 8, 2020 (CN) 202020037704.7

(51) Int. Cl. B60H 1/00; B60H 1/34

(52) U.S. Cl. CPC B60H 1/0065; B60H 1/3421

(57) ABSTRACT

An automobile air conditioner blowing adjusting shifting piece buckle structure comprises a shifting piece body, the shifting piece body comprises an upper shell and a lower shell, and the upper shell and the lower shell are of an integrally-formed structure; the upper shell extends downwards to form a connecting piece; the connecting piece is provided with convex lugs, and shaft holes are formed in the convex lugs; the shaft holes are connected with a shaft pin of a shifting fork; positioning grooves are formed in the peripheries of the shaft holes, and the shaft pin is provided with positioning pieces; the positioning pieces are arranged in the positioning grooves; and the upper shell and the lower shell are of the integrally-formed structure. The upper shell and the lower shell are of the integrally-formed structure, the clamping parts are designed to be connected with the automobile air conditioner blades.

### TECHNICAL FIELD

The present disclosure relates to a buckle structure, in particular to an automobile air conditioner blowing adjusting shifting piece buckle structure.

### BACKGROUND

Currently, most automobile air conditioner air outlets are provided with toggle assemblies for controlling or adjusting the air direction, the toggle assemblies are important functional assemblies of the air outlets and are also appearance parts, and the performance and the appearance of the toggle assemblies directly affect evaluation of clients on the air outlets and interior trims.

A wind direction adjusting shifting piece located at the air outlet of an air conditioner can become brittle and easy to break due to long-term alternate erosion of cold air and hot air, so that the shifting piece needs to be replaced frequently.

Most of existing shifting pieces are shifting piece bodies, fan blades at an air outlet of the air conditioner are fixed in a shifting piece body cavity through the shifting piece body, a fixing piece matched with the shifting piece body cavity is arranged below the shifting fork piece, the upper portion of the shifting piece body cavity is fixed and connected with the shifting fork piece, and the installation combination mode is complex, so that the operation is difficult and the shifting piece is inconvenient to replace when the shifting piece is dismount and mount.

### SUMMARY

To overcome the technical defects, the present disclosure provides an automobile air conditioner blowing adjusting shifting piece buckle structure comprising a shifting piece body, the shifting piece body comprises an upper shell and a lower shell; the upper shell extends downwards to form a connecting piece; the connecting piece is provided with convex lugs, and shaft holes are formed in the convex lugs; the shaft holes are connected with a shaft pin of a shifting fork; positioning grooves are formed in the peripheries of the shaft holes, and the shaft pin is provided with positioning pieces; the positioning pieces are arranged in the positioning grooves; and the upper shell and the lower shell are of an integrally-formed structure, an open groove cavity is formed in the upper shell, an opening is formed in the top of the upper shell, automobile air conditioner blades are clamped into the open groove cavity in the upper shell from the opening in the top of the upper shell, and the automobile air conditioner blades are fixed into the open groove cavity through clamping parts arranged on the upper shell and the lower shell.

Further, the connecting piece is located at one end of the upper shell or the lower shell, the convex lugs are arranged at the two ends of the connecting piece, the shaft holes are formed in the convex lugs, the positioning grooves are formed in the peripheries of one end or two ends of the convex lugs, and the positioning grooves are arc-shaped grooves.

Further, the shifting fork comprises a shifting fork piece, a shaft pin and positioning pieces; the shifting fork piece, the shaft pin and the positioning pieces are integrally formed and designed; the positioning pieces are located above the shaft pin, and one or two positioning pieces are arranged at one end or the left end and the right end of the shaft pin respectively.

Further, the number or the positions of the positioning pieces correspond to that or those of the positioning grooves.

Further, the positioning pieces are located in the positioning grooves and used for positioning rotation of the shifting fork; the radian of the positioning groove at one end of each of the convex lugs is set to be 40-85 degrees; and the radians of the positioning grooves formed in the two ends of the convex lugs are set to be 40-180 degrees.

Further, the clamping parts are arranged at one end of the upper shell and one end of the lower shell or the two ends of the upper shell and the two ends of the lower shell respectively; each clamping part is provided with steps, and one or more steps are arranged according to the shapes of the automobile air conditioner blades respectively.

Further, the convex lugs are vertically arranged or obliquely arranged inwards.

Further, decoration strips are arranged at the bottom of the shifting piece body; and the decoration strips are clamped into the shifting piece body through clamping blocks, and the decoration strips are different according to positions and shapes designed by different vehicle models.

Further, the shifting fork piece is different according to positions and shapes designed by different vehicle models.

Further, antiskid parts or concave operative surfaces are arranged on the surface of the upper shell and the surface of the lower shell.

The automobile air conditioner blowing adjusting shifting piece buckle structure has the advantages that firstly, according to the automobile air conditioner blowing, adjusting shifting piece buckle structure provided by the present disclosure, the upper shell and the lower shell are of an integrally-formed structure, the automobile air conditioner blades are clamped into the open type groove cavity from the opening and fixed into the open type groove cavity through the clamping parts, the structure is simpler, an existing shifting piece body for fixing the automobile air conditioner blades to the shifting piece body through fixing pieces is omitted, and the structure is convenient to mount and dismount; and secondly, due to the design of the positioning grooves and the positioning pieces, the rotating range of the shifting fork is limited in the shifting piece body, and the rotating angle is not too large when the shifting fork is shifted.

### BRIEF DESCRIPTION OF THE DRAWINGS

In order to illustrate the technical solutions in the embodiment of the present disclosure or in the prior art more clearly, the accompanying diagrams needing to be used in the embodiment or in the description in the prior art are simply described. Apparently, the embodiments in the following description are merely a part rather than all of the embodiments of the present disclosure. For those of ordinary skill in the art, under the premise of without contributing creative labor, other accompanying diagrams further can be obtained according to these accompanying diagrams.

FIG. 1 is a diagram of an integral, structure of the present disclosure.

FIG. 2 is, an exploded view of an, integral structure of the present disclosure.

FIG. 3 is a diagram of an integral structure in another embodiment of the present disclosure.

FIG. 4 is an exploded view of an integral structure in another embodiment of the present disclosure.

In the figures, 1, shifting piece body; 11, open groove cavity; 2, upper shell; 21, convex lug; 22, shaft hole; 23, positioning groove; 3, lower shell; 31, clamping part; 32, step; 4, shifting fork; 41, shaft pin; 42, positioning piece; 43, shifting fork; 5, decoration strip; and 51, clamping block.

### DESCRIPTION OF THE EMBODIMENTS

To make a person skilled in the art understand the technical solutions in this application better, the following clearly and completely describes the technical solutions in the embodiments of this application with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

In the description of the present disclosure, the indicative direction or position relations of the terms such as “upper”, “lower”, “left”, “right”, “front”, “back”, “top”, “bottom”, “inner”, “outer”, “middle”, “vertical”, “horizontal”, “transverse” and “longitudinal” are direction or position relations illustrated based on the accompanying diagrams. The terms are mainly used for facilitating the description and embodiments of the present disclosure, but not for indicating or hinting that the indicated device or element must be in a specific direction and is constructed and operated in the specific direction.

Also, besides direction or position relations, some of the terms above may be used to refer to other meanings, for example, the term “on” may also be used to refer to some kind of dependency or connection relationship in some cases. For any person skilled in the art, the specific meanings of the terms in the present disclosure can be understood according to specific conditions.

Moreover, the terms “installed”, “arranged”, “provided”, “connected” and “sleeve joint” should be understood broadly. For example, the connection may be Fixed connection, detachable connection or integral construction; the connection may be mechanical connection or electrical connection; the connection may be direct connection, or indirect connection through an intermediate, or internal communication between two devices, elements or components. For any person skilled in the art, the specific meanings of the terms in the present disclosure can be understood according to specific conditions.

It needs to be illustrated that under the compatible condition, the embodiments in this application and characteristics in the embodiments can be combined mutually. This application will be described in detail below with reference to the accompanying drawings in conjunction with the embodiments.

### Embodiment I

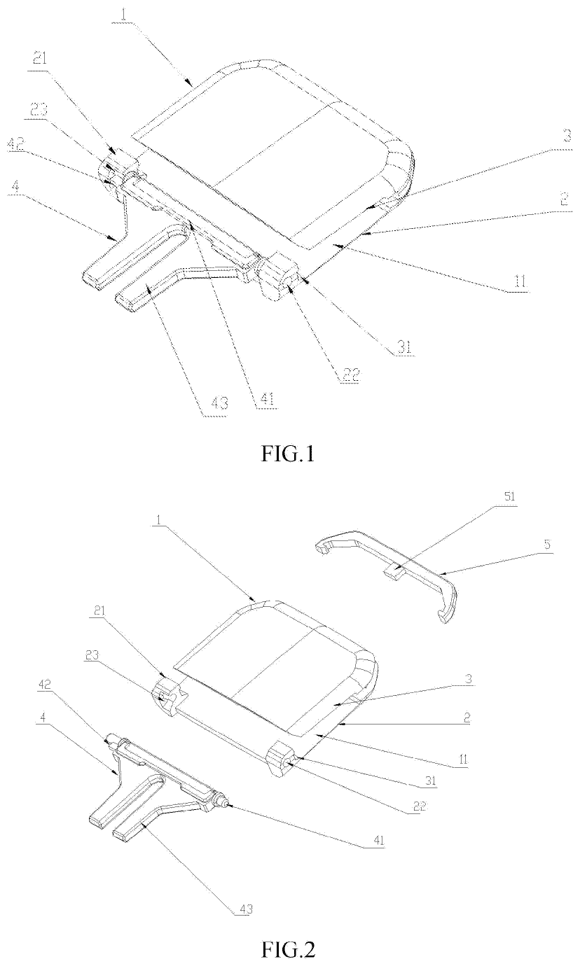

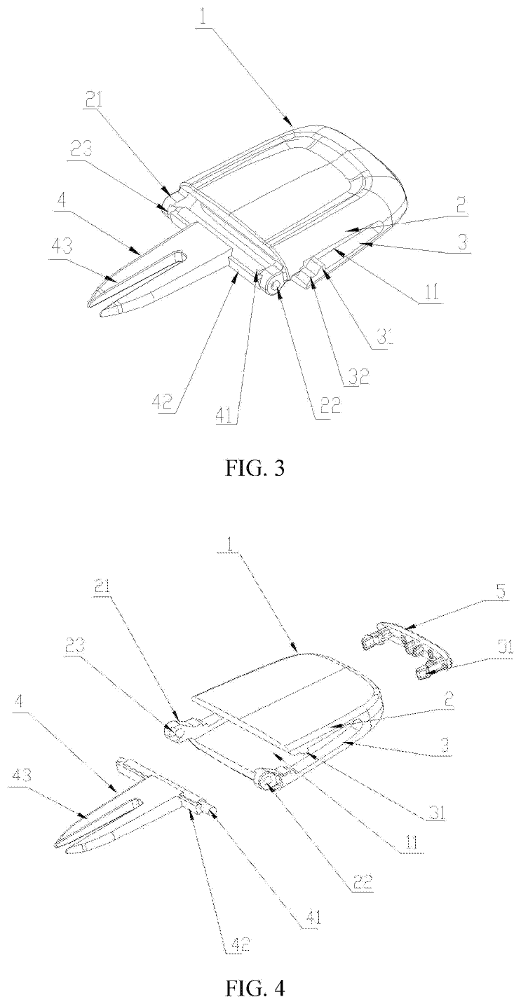

Referring to FIG. 1 to FIG. 2, an automobile air conditioner blowing adjusting shifting piece buckle structure comprising a shifting piece body 1, the shifting piece body 1 comprises an upper shell 2 and a lower shell 3; the upper shell 2 extends downwards to form a connecting piece: the connecting piece is provided with convex lugs 21, shaft holes 22 are formed in the convex lugs 21, and the convex lugs 21 are vertically arranged or obliquely arranged inwards; the shaft holes 22 are connected with a shaft pin 41 of a shifting fork 4, and the shaft pin 41 rotates in the shaft holes 22; positioning grooves 23 are formed in the peripheries of the shaft holes 22, and the shaft pin 41 is provided with positioning pieces 42; the positioning pieces 42 are arranged in the positioning grooves 23 and are used for positioning rotation of the shifting fork 4, and the shifting fork 4 is prevented from being in opposite direction by too large rotating angle due to the action of external force; the radian of the positioning groove at one end of each of the convex lugs 21 is set to be 40-85 degrees; and the radians of the positioning grooves 23 formed in the two ends of the convex lugs 21 are set to be 40-180 degrees.

The upper shell 2 and the lower shell 3 are of an integrally-formed structure, an open groove cavity 11 is formed in the upper shell, an opening is formed in the top of the upper shell, automobile air conditioner blades are clamped into the open groove cavity 11 in the upper shell from the opening in the top of the upper shell, and the automobile air conditioner blades are fixed into the open groove cavity 11 through clamping parts 31 arranged on the upper shell 2 and the lower shell 3; the clamping parts 31 are arranged at one end of the upper shell 2 and one end of the lower shell 3 or the two ends of the upper shell 2 and the two ends of the lower shell 3 respectively; the clamping parts 31 can be arranged at one end of the upper shell 2 and one end of the lower shell 3, and also can be arranged at the two ends of the upper shell 2 or at the two ends of the lower shell 3; each clamping part 31 is provided with steps 32, and the steps 32 play a role of buttering connection in order to facilitate the automobile air conditioner blades to fall into the open groove cavity 11; and one or more steps 32 are arranged according to the shapes of the automobile air conditioner blades respectively.

The shifting fork 4 comprises a shifting fork piece 43, a shaft pin 41 and positioning pieces 42; the shifting fork piece 43, the shaft pin 31 and the positioning pieces 42 are integrally formed and designed; the positioning pieces 42 are located above the shaft pin 41, and one or two positioning pieces 42 are arranged at, one end or the left end and the right, end of the shaft pin 41 respectively.

Decoration strips 5 are arranged at the bottom of the shifting piece body 1; the decoration strips 5 are clamped into the shifting piece body 1 through clamping block 51, and one or more decoration strips 51 are arranged; and the decoration strips 5 are different according to positions and shapes designed by different vehicle models, and can be mounted or dismounted according to personal preference.

The shifting fork piece 43 is different according to positions and shapes designed by different vehicle models, and the shape, the position, the size and the like of the shifting fork piece 43 can be designed according to different vehicle models and are not restricted factors.

Antiskid parts or concave operative surfaces are arranged on the surface of the upper shell 2 and the surface of the lower shell 3, and friction is generated so that the shifting piece body 1 is convenient to a user to control.

### Embodiment II

The connecting piece is located at one end of the upper shell 2 or one end of the lower shell 3 or the upper shell 2 is provided with the connecting piece and the lower shell 3 is provided with a clamping part 31, or the lower shell 3 is provided with the connecting piece, and the upper shell 2 is provided with the clamping part 31, which is not a factor for restricting the protection range of the present disclosure; and the convex lugs 21 are arranged at the two ends of the connecting piece, shaft holes 22 are formed in the convex lugs 21, positioning grooves 23 are formed in the peripheries of one ends or the two ends of the convex lugs 21, the angles of the positioning grooves 23 in one end of each of the convex lugs 21 are different from those of the positioning grooves 23 in the two ends of the convex lugs 21, and the positioning grooves 23 are arc-shaped grooves.

### Embodiment III

According to the working principle, the shifting piece body 1 is clamped into the automobile air conditioner blades through the opening, so that the automobile air conditioner blades are placed in the open type groove cavity 11, and the shifting fork piece 43 clamps the blades in an air conditioner; when force in the horizontal direction is exerted on the shifting fork body 1, friction is generated by the anti-skid parts or concave operative surfaces, the shifting piece body 1 slides on the automobile air conditioner blades, the shifting fork piece 43 clamps the blades in the air conditioner to horizontally adjust the direction of an air outlet, and therefore the air outlet direction of the air conditioner is adjusted; and force in the vertical direction is exerted on the shifting fork body 1, friction is generated by the anti-skid parts or concave operative surfaces, the air outlet direction of the automobile air conditioner blades is vertically adjusted, and therefore the air outlet direction of the air conditioner is adjusted, and finally the decoration strips are installed or not according to personal preference.

According to the automobile air conditioner blowing adjusting shifting piece buckle structure provided by the present disclosure, the upper shell and the lower shell are of an integrally-formed structure, the automobile air conditioner blades are clamped into the open type groove cavity from the opening and fixed into the open type groove cavity through the clamping parts, the structure is simpler, an existing shifting piece body for fixing the automobile air conditioner blades to the shifting piece body through fixing pieces is omitted, and the structure is convenient to mount and dismount; and secondly, due to the design of the positioning grooves and the positioning pieces, the rotating range of the shifting fork is limited in the shifting piece body, and the rotating angle is not too large when the shifting fork is shifted.

The foregoing descriptions are merely exemplary embodiments of the present disclosure, but are not intended to limit the present disclosure, and for the skill in the art, the present disclosure can be of various modifications and changes. Any modification, equivalent replacement, or improvement made without departing from the spirit and principle of this application shall fall within the protection scope of this application.

What is claimed is:

1. An automobile air conditioner blowing adjusting shifting piece buckle structure comprising a shifting piece body, characterized in that the shifting piece body comprises an upper shell and a lower shell; the upper shell extends downwards to form a connecting piece; the connecting piece is provided with convex lugs, and, shaft holes are formed in the convex lugs; the shaft holes are connected with a shaft pin of a shifting fork;
positioning grooves are formed in the peripheries of the shaft holes, and the shaft pin is provided with positioning pieces; the positioning pieces are arranged in the positioning grooves; and
the upper shell and the lower shell are of an integrally-formed structure, an open groove cavity is formed in the upper shell, an opening is formed in the top of the upper shell, automobile air conditioner blades are clamped into the open groove cavity in the upper shell from the opening in the top of the upper shell, and the automobile air conditioner blades are fixed into the open groove cavity through clamping parts arranged on the upper shell and the lower shell.

2. The automobile air conditioner blowing adjusting shifting piece buckle structure according to claim 1, characterized in that the connecting piece is located at one end of the upper shell or the lower shell the convex lugs are arranged at the two ends of the connecting piece, the shaft holes are formed in the convex lugs, the positioning grooves are formed in the peripheries of one end or two ends of the convex lugs, and the positioning grooves are arc-shaped grooves.

3. The automobile air conditioner blowing adjusting shifting piece buckle structure according to claim 1, characterized in that the shifting fork comprises a shifting fork piece, a shaft pin and positioning pieces; the shifting fork piece, the shaft pin and the positioning pieces are integrally formed and designed; the positioning pieces are located above the shaft pin, and one or two positioning pieces are arranged at one end or the left end and the right end of the shaft pin respectively.

4. The automobile air conditioner blowing adjusting shifting piece buckle structure according to claim 2, characterized in that the number or the positions of the positioning pieces correspond to that or those of the positioning grooves.

5. The automobile air conditioner blowing adjusting shifting piece buckle structure according to claim 3, characterized, in that the number or the positions of the positioning pieces correspond to that or those of the positioning grooves.

6. The automobile air conditioner blowing adjusting shifting piece buckle structure according to claim 1, characterized, in that the positioning pieces are located in the positioning, grooves and used for positioning rotation of the shifting fork; the radian of the positioning groove at one end of each of the convex lugs is set to be 40-85 degrees; and the radians of the positioning grooves formed in the two ends of the convex lugs are set to be 40-180 degrees.

7. The automobile air conditioner blowing adjusting shifting piece buckle structure according to claim 2, characterized in that the positioning pieces are located in the positioning grooves and used for positioning rotation of the shifting fork; the radian of the positioning groove at one end of each of the convex lugs is set to be 40-85 degrees; and the radians of the positioning grooves formed in the two ends of the convex lugs are set to be 40-180 degrees.

8. The automobile air conditioner blowing adjusting shifting piece buckle structure according to claim 3, characterized in that the positioning pieces are located in the positioning grooves and used for positioning rotation of the shifting fork; the radian of the positioning groove at one end of each of the convex lugs is set to be 40-85 degrees; and the radians of the positioning grooves formed in the two ends of the convex lugs are set to be 40-180 degrees.

9. The automobile air conditioner blowing adjusting shifting piece buckle structure according to claim 1, characterized in that the clamping parts are arranged at one end of the upper shell and one end of the lower shell or the two ends of the upper shell and the two ends of the lower shell respectively; each clamping part is provided with steps, and one or more steps are arranged according to the shapes of the automobile air conditioner blades respectively.

10. The automobile air conditioner blowing adjusting shifting piece buckle structure according to claim 2, characterized in that the convex lugs are vertically arranged or obliquely arranged inwards.

11. The automobile air conditioner blowing adjusting shifting piece buckle structure according to claim 1, characterized, in that decoration strips are arranged at the bottom of the shifting piece body; and the decoration strips are clamped into the shifting piece body through clamping blocks, and the decoration strips are different according to positions and shapes designed by different vehicle models.

12. The automobile air conditioner blowing adjusting shifting piece buckle structure according to claim 3, characterized in that the shifting fork piece is different according to positions and shapes designed by different vehicle models.

13. The automobile air conditioner blowing adjusting shifting piece buckle structure according to claim 1, characterized in that antiskid parts or concave operative surfaces are arranged on the surface of the upper shell and the surface of the lower shell.
